(19) United States
(12) Patent Application Publication
(10) Pub. No.: US 2013/0311489 A1
(43) Pub. Date: Nov. 21, 2013

(54) Systems and Methods for Extracting Names From Documents

(71) Applicant: Alex Kerschhofer, Mountain View, CA (US)

(72) Inventor: Alex Kerschhofer, Mountain View, CA (US)

(73) Assignee: GOOGLE INC., Mountain View, CA (US)

(21) Appl. No.: 13/250,146

(22) Filed: Sep. 30, 2011

(51) Int. Cl. G06F 17/30

(52) U.S. Cl. 707/754; 707/E17.022

(57) ABSTRACT

A method for automatically extracting names that is implemented by a computer having a computer memory includes the steps of storing a list of first names in the computer memory; receiving a document in the computer memory, where at least some of the characters of the document are represented in a machine readable format; identifying a grouping of words in the document as a name candidate based on capitalization of a leading character of at least two of the words; selecting a subject word of the name candidate; comparing the subject word to the list of first names; and determining that the name candidate includes a personal name if the subject word is present in the list of first names, using the computer.

### TECHNICAL FIELD

The disclosure relates to the field of document analysis, and more particularly, to systems and methods for extracting names from documents.

### BACKGROUND

Computer programs that attempt to understand the content of documents are well known. For certain applications, it can be valuable to identify personal names within documents. Known methods recognize personal names in documents using dictionaries and grammatical text analysis. The algorithms for implementing these methods can be complex, difficult to write, and language dependent, and their execution requires high processor and memory usage.

### SUMMARY

Disclosed herein are systems and methods for extracting names from documents.

One aspect of the embodiments taught herein is a method for automatically extracting names that is implemented using a computer having a computer memory. The method includes the steps of storing a list of first names in the computer memory; receiving a document in the computer memory, where at least some of the characters of the document are represented in a machine readable format; identifying a grouping of words in the document as a name candidate based on capitalization of a leading character of at least two of the words; selecting a subject word of the name candidate; comparing the subject word to the list of first names; and determining that the name candidate includes a personal name if the subject word is present in the list of first names.

Another aspect of the embodiments taught herein is a method for automatically extracting names that is implemented by a computer having a computer memory. The method includes the steps of storing a list of first names in the computer memory; storing a listing of non-capitalized name elements in the computer memory; receiving a document in the computer memory, where at least some of the characters of the document are represented in a machine readable format; identifying a grouping of words in the document as a name candidate if the grouping of words is contiguous and consists of capitalized words and non-capitalized name elements; selecting a subject word of the name candidate; comparing the subject word to the list of first names; determining that the name candidate includes a personal name if the subject word is present in the list of first names; and producing an output including the personal name.

Another aspect of the embodiments taught herein is a system for automatically extracting names that includes a list of first names that is stored in a computer readable format; and a computer having a computer memory. The computer is operable to receive a document in the computer memory, where at least some of the characters of the document are represented in a machine readable format; identify a grouping of words in the document as a name candidate based on capitalization of a leading character of at least two of the words; select a subject word of the name candidate; compare the subject word to the list of first names; and determine that the name candidate includes a personal name if the subject word is present in the list of first names.

### BRIEF DESCRIPTION OF THE DRAWINGS

The description herein makes reference to the accompanying drawings wherein like reference numerals refer to like parts throughout the several views, and wherein:

FIG. 1 is block diagram showing an exemplary environment for operation of a system for extracting names from documents;

FIG. 2 is a diagram illustrating operation of a system for extracting names from documents;

FIG. 3 is block diagram showing an exemplary environment for operation of a system for extracting names from documents that are received from a web crawler;

FIG. 4 is a flow chart showing an exemplary process for extracting names from documents; and

FIG. 5 is a block diagram showing an exemplary computer system.

### DETAILED DESCRIPTION

The disclosure herein is directed to systems and methods for extracting names from documents. Instead of relying on dictionaries containing first names and surnames, and applying those dictionaries to parse and analyze a document using a complicated algorithm, the systems and methods described herein rely on capitalization to identify name candidates. A name candidate is a grouping of words that might contain one or more names. The name candidates are analyzed using a dictionary of first names, and exclusionary rules can be applied to reduce false positives.

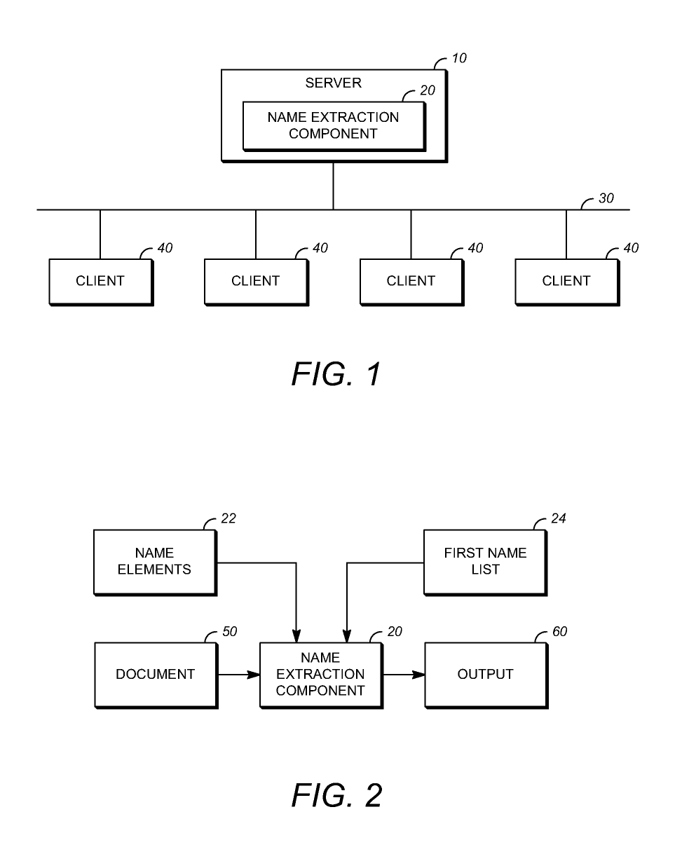

FIG. 1 is a diagram showing a system for extracting personal names from documents implemented in an exemplary environment. As used herein, a personal name is a name that refers to a person.

A server 10 includes a name extraction component 20. In one exemplary embodiment, a network 30 connects the server 10 to one or more clients 40. The clients 40 are in communication with the server 10 for the purpose of utilizing the name extraction functionality of the server 10 via the name extraction component 20. The server 10 and each client 40 can be a single system or multiple systems. The network 30 allows communication between the server 10 and the clients 40 in any suitable manner.

The name extraction component 20 can be a software component that is executed by the server 10, or by any other suitable computing device. As shown in FIG. 2, a document 50 is provided to the name extraction component 20 as an input. As an example, the document 50 can be transmitted to the server 10, and stored in a computer memory of the server 10, where the computer memory is any suitable type of data storage that is associated with the server 10. The name extraction component 20 processes the document 50 and produces an output 60. As an example, the name extraction component 20 can be a web application that is written in the Java programming language and uses regular expressions to identify characters, words, strings and other elements of the document.

The document 50 can be any type of document that is in a computer-readable format. Thus, the document 50 can contain numerous characters, where all of the characters of the document 50 or at least some of the characters of the document 50 are represented in a machine readable format. As one example, the document 50 can be a plain text document, where the characters of the document are represented by ASCII character codes. As another example, the document 50 can be a text document with formatting information. The document 50 could be a markup language document. As an example of a suitable markup language, the document 50 could be a HyperText Markup Language (HTML) document.

The output 60 includes text from the document 50 that has been identified as a personal name by the name extraction component 20. The output 60 can be provided in many suitable forms. In one example, the output 60 is in the form of a list of personal names. In another example, the output 60 is produced by modifying the document 50 to indicate that a grouping of words in the document 50 is a personal name.

If the document 50 is an HTML document, the document 50 can be modified by embedding tags into the document 50 that identify the personal names. A <meta> tag can be used for this purpose. As an example, if the name “Joe Smith” appears in the document 50 the following tag can be inserted into the document to identify the presence of the name: <meta name=“person” content=“Joe Smith”>.

After receiving the document 50, the name extraction component 20 parses the document 50. First, the name extraction component 20 identifies a grouping of words in the document 50 as a name candidate. The grouping of words that is identified by the name extraction component 20 is a contiguous grouping of words. As used herein, the term “word” includes any symbol or designation that stands apart from other words or symbols (i.e. separated by a space character), such as an initial. As an example, a grouping of ASCII character codes that represent contiguous non-space characters can be considered a word.

The name extraction component 20 identifies the grouping of words in the document 50 as a name candidate based on capitalization of a leading character of at least two of the words. This is in recognition of the fact that a personal name is typically comprised of at least a first name or initial and a surname, both of which are usually capitalized.

When identifying a grouping of words in the document 50 as a name candidate, the name extraction component can selectively exclude portions of the document 50 based on formatting information contained in the document 50. If the document 50 is an HTML document the formatting information that is utilized to exclude portions of the document 50 can include HTML tags that are included within the document 50. For example, headings within documents are typically written in capital letters. If a heading is enclosed in HTML heading tags, such as <h1>, <h2>, etc., the text within the tags can be excluded from the portions of the document 50 that are analyzed to detect name candidates.

The grouping of words of the document 50 that is identified by the name extraction component 20 as a name candidate need not consist solely of capitalized words. Instead, the grouping of words can include both capitalized words and non-capitalized name elements. Non-capitalized name elements are words, symbols or punctuation marks that can appear as part of a name. As an example, the non-capitalized name elements can include hyphens.

As a further example, the non-capitalized name elements can include either or both of prefixes and infixes. Examples of infixes that can be included in the non-capitalized name elements are: zu, von, van, de, du, del, della, da, do, van't, el, and bin. Examples of prefixes that can be included in the non-capitalized name elements are: d′, l′, el, and al. These examples are not exhaustive, but rather, are intended only as examples of elements that can be included in the non-capitalized name elements.

The non-capitalized name elements can be provided to the name extraction component 20 in the form of a list of non-capitalized name elements 22. As an example, the list of non-capitalized name elements 22 can be received by the server 10 and stored in the computer memory of the server 10 during execution of the name extraction component 20.

The list of non-capitalized name elements 22 can be encoded in a machine readable format, such as an ASCII based text document or data table. In one exemplary embodiment, the list of non-capitalized name elements 22 can be stored in a computer readable medium that is associated with the server 10. As an alternative, the list of non-capitalized name elements 22 can be incorporated in the name extraction component 20. For example, the name extraction component 20 can be provided in the form of executable instructions that are executed by the server 10, and the list of non-capitalized name elements 22 can be incorporated directly into the executable instructions. Thus, the process employed by the name extraction component 20 for identifying a grouping of words as a name candidate can include determining that the grouping of words is a name candidate if the grouping of words is contiguous and consists of capitalized words and non-capitalized name elements.

After the name candidate is identified by the name extraction component 20, it is processed to determine whether the name candidate is a personal name or includes one or more personal names. This determination is made on the basis of the presence or absence of a known first name within the name candidate.

The name extraction component can be provided with a dictionary of known first names, such as a first name list 24 that is encoded in a machine readable format, such as an ASCII based text document or data table. As an example, the first name list 24 can be received by the server 10 and stored in the computer memory of the server 10 during execution of the name extraction component 20.

In one exemplary embodiment, two or more of the words that make up the name candidate are selected as subject words. The subject words are compared to the known first names that are contained within the first name list 24. If a known first name is found within the name candidate, the name extraction component 20 can determine that the name candidate includes a personal name. Thus, the name extraction component can determine whether a name candidate includes a personal name by selecting a subject word of the name candidate, comparing the subject word to the list of known first names within the first name list 24, and determining that the name candidate includes a personal name if the subject word is present in the first name list 24.

In one exemplary embodiment, the first name list 24 can be a language specific first name list. The language specific first name list is selected as the first name list 24 based on the language in which the document 50 is written, which can be an input that is provided to the name extraction component 20 with or as part of the document 50, or can be detected using known algorithms. The language specific first name list can, in some cases, eliminate first names that are also common words in the selected language. This can be accomplished be an algorithm that eliminates first names from the first name list 24 if the first name is more likely a simple word rather than a name in the language corresponding to the language specific first name list.

As an example, without a language specific first name list as the first name list 24, analysis of the German language sentence “Allen Opfern des Zugsunglückes wurde eine Entschädigung zugesprochen” (All victims of the train accident a compensation was granted) by the name extraction component would result in identification of Allen Opfern as a first name, which is false. By providing a language specific first name list as the first name list 24 for the German language that excludes the name “Allen,” false positive results are avoided. Of course, the first name list 24 need not be language specific, and either of a language specific first name list or a non-language specific first name list can be utilized with acceptable results.

Comparison of the name candidate need not include comparison of all of the words in the name candidate to the known first names that are contained within the first name list 24. As an example, when selecting the subject words of the name candidate, the name extraction component 20 can exclude a final word of the name candidate such that it will not be selected as the subject word, as the final word of the name candidate is, in many cultures, typically a surname. As another example, the name extraction component 20 can exclude non-capitalized name elements of the name candidate, such that they will not be selected as the subject word.

In one exemplary embodiment, if one or more of the subject words of the name candidate are not first names, the name extraction component can be configured to conclude that the name candidate does not include a personal name. If one or more of the subject words of the name candidate is a first name, the name extraction component can be configured to conclude that the name candidate is a personal name or includes a personal name. The subject words of the name candidate are processed in order of appearance within the name candidate. The first occurrence of a known first name is utilized as the beginning of the personal name.

In one exemplary embodiment, if a known first name is detected within the name candidate, the known first name and the portion of the name candidate subsequent to the known first name are determined to be a personal name. In another exemplary embodiment, if a known first name is detected within the name candidate, the known first name, the next capitalized word appearing within the name candidate, and intervening non-capitalized name elements, if any, are determined to be a personal name.

Optionally, after one or more subject words of the name candidate are determined to be first names, the name extraction component can apply exclusion rules that determine whether aspects of the name candidate indicate that its identification as a personal name on the basis of inclusion of a first name is a likely false positive result. As an example, HTML tag information or other formatting information can be utilized as the basis for an exclusion rule, in a manner similar to that previously discussed with regard to excluding portions of the document 50 as name candidates. As another example, a listing of known false positive results can be used as a basis for an exclusion rule, by determining that the name candidate does not include a personal name if it is known to not be a personal name by virtue of its inclusion in the listing of known false positive results. Also, the exclusion rule could apply a language specific listing of known false positive results. The language specific listing of known false positive results is selected based on the language in which the document is written, which can be provided to the name extraction component 20 with or as part of the document 50, or can be detected using known algorithms.

Optionally, after one or more subject words of the name candidate are determined to be first names, the name extraction component 20 can also identify one or more words of the name candidate as a surname. For example, the name extraction component 20 can be configured to identify a final word of the name candidate as being a surname or a portion of a surname.

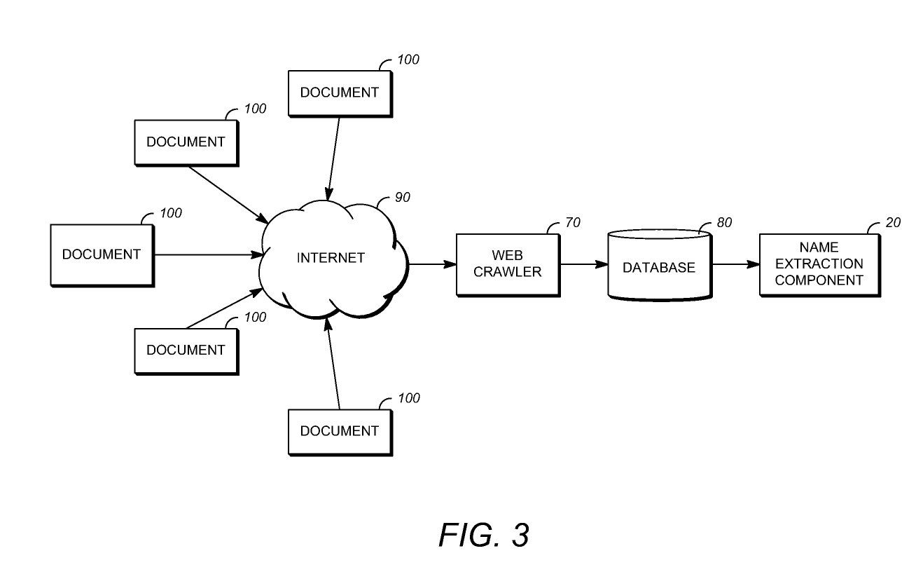

A further example of an environment in which the name extraction component can be utilized is shown in FIG. 3. A web crawler 70 includes a database 80. The web crawler 70 connects to remote systems using a network such as the internet 90 to identify and collect a plurality of documents 100. In this example, the documents 100 are HTML documents. The documents 100 are stored in the database 80. The name extraction component 20 processes the documents 100 that are stored in the database 80 to identify personal names within the documents 100, in the same manner as described above in connection with the documents 50. When a personal name is identified, the document 100 is modified to include a <meta> tag that includes the personal name, and the document 100, as modified, is stored in the database 80 as output. The personal name information that is now included in the document 100 can be utilized by other processes or systems, such as a ranking function of a search engine.

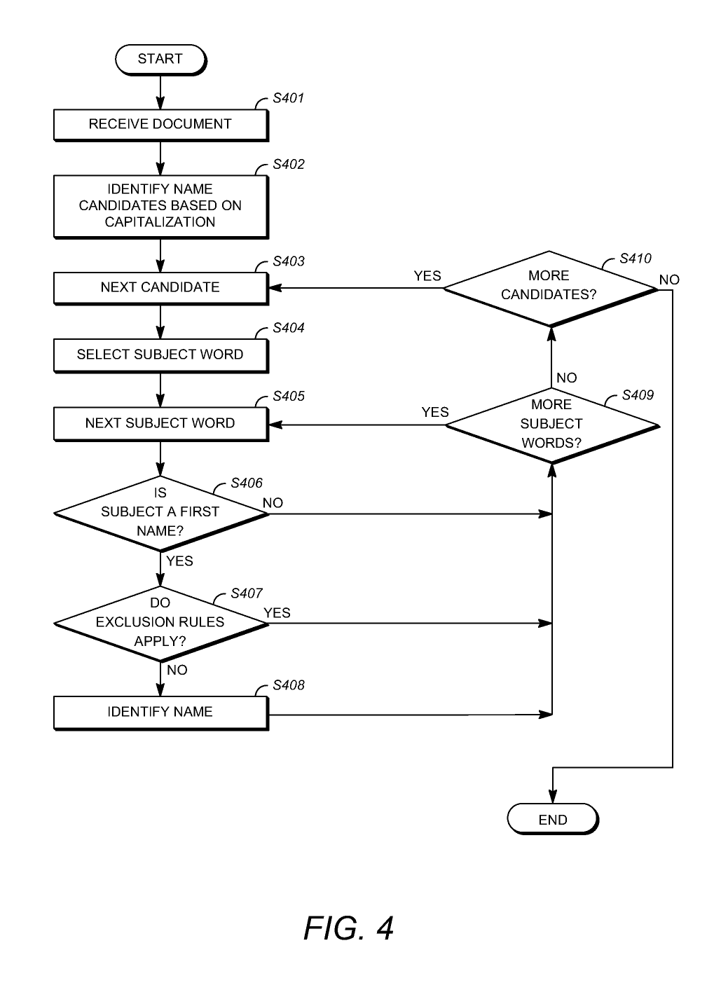

An exemplary process for extracting names from the documents 50 will now be explained with reference to FIG. 4.

When the name extraction process of the name extraction component 20 starts, the document 50 is retrieved in Step S401, for example, from the database 80 (FIG. 3). In step S402, one or more name candidates within the document 50 are identified based on capitalization, as previously described.

The next name candidate is selected for analysis in step S403. Initially, the name candidate that appears first within the document 50 is selected for analysis. Subsequent iterations of step S403, if necessary, will select subsequently appearing name candidates for analysis.

In step S404, one or more subject words are selected for analysis. In one example, the first capitalized word that appears in the name candidate is selected for analysis. In another example, two or more of the capitalized words that appear in the name candidate are selected for analysis.

In step S405, the next subject word is selected for analysis. Initially, the first subject word that appears in the name candidate is selected for analysis. Subsequent iterations of Step S405, if necessary, will select subsequently appearing subject words for analysis.

In step S406, the name extraction component 20 determines whether the subject word is a first name, using the first name list 24, as previously described. If the subject word is a first name, step S406 evaluates as “YES” and the process continues to step S407. If the subject word is not a first name, step S406 evaluates as “NO” and the process continues to step S409.

In step S407, which is optional, the name extraction component determines whether exclusion rules apply, as previously described. If exclusion rules apply, step S407 evaluates as “YES” and the process continues to step S409. If exclusion rules do not apply, step S407 evaluates as “NO” and the process continues to step S408.

In step S408 the name extraction component 20 concludes that the name candidate includes a personal name, and the name extraction component identifies the personal name. As previously noted, in one example, the subject word that is determined to be a first name and the following subject word (and possible infixes inbetween) can be identified as a personal name. In order to evaluate the remaining subject words of the current name candidate, if any, to determine whether the name candidate includes additional personal names, the process continues to step S409.

In step S409, the name extraction component determines whether more subject words remain to be processed. If subject words that were identified in step S404 have not yet been processed, step S409 evaluates as “YES” and the process returns to step S405, where the next subject word is selected. Otherwise, step S409 evaluates as “NO” and the process proceeds to step S410.

In step S410, the name extraction component determines whether more name candidates are to be processed. If the document 50 contains more name candidates to be processed, step S410 evaluates as “YES” and the process returns to step S403. If the document 50 does not contain more name candidates to be processed, step S410 evaluates as “NO” and the process ends.

As a result of the foregoing process, a document can be processed by the name extraction component, and personal names that appear within the document can be identified. In addition, this process can be implemented such that it has an order of growth of O(n), whereas known previous processes have an order of growth of O(n̂2).

The server 10, the name extraction component 20, the clients 40, the web crawler 70, the database 80, and other elements of the systems discussed in this disclosure can be implemented in the form of one or more machines or devices capable of performing the described functions. These devices could be or include a processor, a computer, specialized hardware or any other device. The described functionality can be embodied in software instructions that are executable by the device or devices.

As used herein, the term “computer” means any device of any kind that is capable of processing a signal or other information. Examples of computers include, without limitation, an application-specific integrated circuit (ASIC) a programmable logic array (PLA), a microcontroller, a digital logic controller, a digital signal processor (DSP), a desktop computer, a laptop computer, a tablet computer, and a mobile device such as a mobile telephone. A computer does not necessarily include memory or a processor. A computer may include software in the form of programmable code, micro code, and or firmware or other hardware embedded logic. A computer may include multiple processors which operate in parallel. The processing performed by a computer may be distributed among multiple separate devices, and the term computer encompasses all such devices when configured to perform in accordance with the disclosed embodiments.

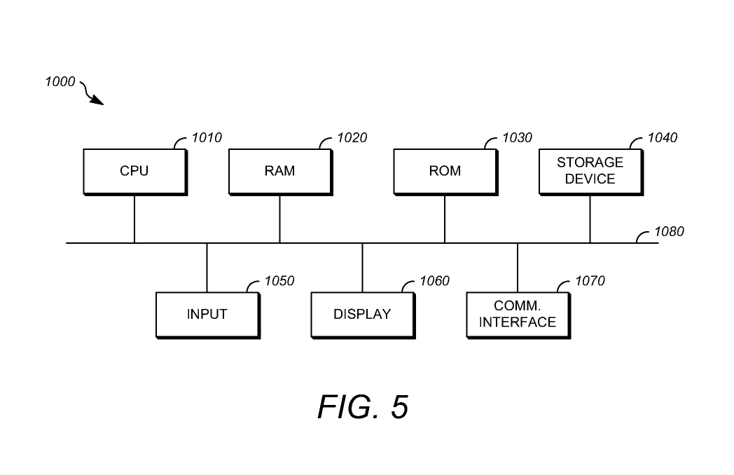

An example of a device that can be used as a basis for implementing the systems and functionality described herein is a conventional computer 1000, as shown in FIG. 5. The conventional computer 1000 can be any suitable conventional computer. As an example, the conventional computer 1000 includes a processor such as a central processing unit (CPU) 1010 and memory such as RAM 1020 and ROM 1030. A storage device 1040 can be provided in the form of any suitable computer readable medium, such as a hard disk drive. One or more input devices 1050, such as a keyboard and mouse, a touch screen interface, etc., allow user input to be provided to the CPU 1010. A display 1060, such as a liquid crystal display (LCD) or a cathode-ray tube (CRT), allows output to be presented to the user. A communications interface 1070 is any manner of wired or wireless means of communication that is operable to send and receive data or other signals using the communications network 50. The CPU 1010, the RAM 1020, the ROM 1030, the storage device 1040, the input devices 1050, the display 1060 and the communications interface 1070 are all connected to one another by a bus 1080.

The server 10, the name extraction component 20, the clients 40, the web crawler 70, the database 80, and other elements of the systems discussed in this disclosure can be implemented in the form of a single system or in the form of separate systems. Moreover, each of the server 10, the name extraction component 20, the clients 40, the web crawler 70, the database 80, and other elements of the systems discussed in this disclosure can be implemented in the form of multiple computers, processors, or other systems working in concert. As an example, the functions of the server 10 can be distributed among a plurality of conventional computers, such as the computer 1000, each of which are capable of performing some or all of the functions of the server 10.

As previously noted, components of the systems described herein can be connected for communications with one another by networks such as the network 30 or the internet 90. The designations are made for ease of description. The communications functions described herein can be accomplished using any kind of network or communications means capable of transmitting data or signals. Suitable examples include the internet, which is a packet-switched network, a local area network (LAN), wide area network (WAN), virtual private network (VPN), or any other means of transferring data. A single network or multiple networks that are connected to one another can be used. It is specifically contemplated that multiple networks of varying types can be connected together and utilized to facilitate the communications contemplated by the systems and elements described in this disclosure.

While the disclosure is directed to what is presently considered to be the most practical embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A method for automatically extracting names that is implemented by a computer having a computer memory, comprising:
storing a list of first names in the computer memory;
receiving a document in the computer memory, where at least some characters of the document are represented in a machine readable format;
identifying a grouping of words in the document as a name candidate based on capitalization of a leading character of at least two of the words;
selecting a subject word of the name candidate;
comparing the subject word to the list of first names; and
determining that the name candidate includes a personal name if the subject word is present in the list of first names without comparing any portion of the name candidate to known surnames.

2. The method of claim 1, further comprising:
storing a listing of non-capitalized name elements in the computer memory, wherein identifying a grouping of words as a name candidate includes determining that the grouping of words is a name candidate if the grouping of words is contiguous and consists of capitalized words and non-capitalized name elements.

3. The method of claim 2, wherein the listing of non-capitalized name elements includes prefixes and infixes.

4. The method of claim 1, wherein identifying a grouping of words in the document as a name candidate includes selectively excluding portions of the document based on formatting information contained in the document.

5. The method of claim 4, wherein the formatting information includes markup language tags.

6. The method of claim 1, wherein selecting the subject word of the name candidate includes excluding a final word of the name candidate.

7. The method of claim 1, wherein selecting the subject word of the name candidate includes excluding non-capitalized name elements of the name candidate.

8. The method of claim 1, further comprising:
detecting a language in which the document is written as a subject language; and
selecting a language specific first name listing that corresponds to the subject language, wherein providing a list of first names includes using the language specific first name listing as the list of first names.

9. The method of claim 8, further comprising:
providing the language specific first name listing by excluding non-name common words from a non-language specific name listing based on the subject language.

10. The method of claim 1, further comprising:
determining that one or more words of the name candidate subsequent to the subject word is a surname if the subject word is present in the list of first names.

11. The method of claim 1, further comprising:
determining that a final word of the name candidate is at least part of a surname if the subject word is present in the list of first names.

12. The method of claim 1, further comprising:
producing an output including the personal name.

13. The method of claim 12, wherein producing the output includes modifying the document to indicate the grouping of words as the personal name.

14. A method for automatically extracting names that is implemented by a computer having a computer memory, comprising:
storing a list of first names in the computer memory;
storing a listing of non-capitalized name elements in the computer memory;
receiving a document in the computer memory, the document including a plurality of characters, where at least some of the characters of the document are represented in a machine readable format;
identifying a grouping of words in the document as a name candidate if the grouping of words is contiguous and consists of capitalized words and non-capitalized name elements;
selecting a subject word of the name candidate;
comparing the subject word to the list of first names;
determining that the name candidate includes a personal name if the subject word is present in the list of first names without comparing any portion of the name candidate to known surnames; and
producing an output including the personal name.

15. The method of claim 14, wherein the listing of non-capitalized name elements include prefixes and infixes.

16. The method of claim 14, wherein identifying a grouping of words in the document as a name candidate includes selectively excluding portions of the document based on formatting information contained in the document.

17. The method of claim 16, wherein the formatting information includes markup language tags.

18. The method of claim 14, wherein selecting the subject word of the name candidate includes excluding a final word of the name candidate.

19. The method of claim 14, wherein selecting the subject word of the name candidate includes excluding non-capitalized name elements of the name candidate.

20. The method of claim 14, further comprising:
detecting a language in which the document is written as a subject language;
selecting a language specific first name listing that corresponds to the subject language; and
using the language specific first name listing as the list of first names.

21. The method of claim 20, further comprising:
providing the language specific first name listing by excluding non-name common words from a non-language specific name listing based on the subject language.

22. The method of claim 14, further comprising:
determining that one or more words of the name candidate subsequent to the subject word is a surname if the subject word is present in the list of first names.

23. The method of claim 14, further comprising:
determining that a final word of the name candidate is at least part of a surname if the subject word is present in the list of first names.

24. The method of claim 14, wherein producing the output includes modifying the document to indicate the grouping of words as the personal name.

25. A system for automatically extracting names, comprising:
a list of first names that is stored in a computer readable format; and
a computer having a computer memory, where the computer is operable to:
receive a document in the computer memory, the document including a plurality of characters where at least some of the characters of the document are represented in a machine readable format;
identify a grouping of words in the document as a name candidate based on capitalization of a leading character of at least two of the words;
select a subject word of the name candidate;
compare the subject word to the list of first names; and
determine that the name candidate includes a personal name if the subject word is present in the list of first names without comparing any portion of the name candidate to known surnames.
